(19) United States
(12) Patent Application Publication
(10) Pub. No.: US 2021/0267196 A1
(43) Pub. Date: Sep. 2, 2021

(54) SURFACTANT COMBINATION FOR AGROCHEMICAL FORMULATIONS

(71) Applicant: Bayer Aktiengesellschaft, Leverkusen (DE)

(72) Inventor: Arianna MARTELLETTI, Sulzbach im Taunus (DE)

(21) Appl. No.: 17/264,188

(22) PCT Filed: Jul. 30, 2019
(86) PCT No.: PCT/EP2019/070419

§ 371 Date: Jan. 28, 2021

(30) Foreign Application Priority Data
Jul. 31, 2018 (EP) 18186730.0

(51) Int. Cl. A01N 25/30; A01N 43/707; A01N 25/02

(52) U.S. Cl. CPC A01N 25/30; A01N 25/02; A01N 43/707

(57) ABSTRACT

Surfactant combination for agrochemical (crop protection) formulations with increased shelf life and reduced crystallization, in particular for agrochemical formulations comprising Metribuzin and Isoxaflutole. The invention relates to the technical field of surfactant combinations for crop protection formulations with increased shelf life and reduced crystallization, in particular herbicidal formulations, and formulations containing said adjuvant combinations, as well as methods for producing said formulations.

Surfactant combination for agrochemical (crop protection) formulations with increased shelf life and reduced crystallization, in particular for agrochemical formulations comprising Metribuzin and Isoxaflutole.

The invention relates to the technical field of surfactant combinations for crop protection formulations with increased shelf life and reduced crystallization, in particular herbicidal formulations, and formulations containing said surfactant combinations, as well as methods for producing said formulations.

In a preferred embodiment, the instant invention relates to highly loaded aqueous formulations of herbicides, in particular aqueous formulations containing metribuzin and isoxaflutole.

Active substances can in principle be formulated in a great variety of ways, wherein the properties of the active substances and the nature of the formulation can lead to problems with regard to the processing, stability, usability and effectiveness of the formulations. In addition, for economic and ecological reasons certain formulations are more advantageous than others.

Water-based formulations, such as aqueous suspension concentrates (SC), as a rule have the advantage that they require a low to zero content of organic solvents. Aqueous suspension concentrates for the formulation of active substances are known from the agrochemicals field. Thus for example aqueous suspension concentrates of pesticides are described in WO 2011018188 A1 and EP 0110174 A. In the latter a mixture of formaldehyde condensation products or lignosulfonates and wetting agents is preferably used.

Apart from this, there is in general a demand for highly concentrated (highly loaded) formulations of active substances, since the higher concentration has many advantages. Thus for example with highly concentrated formulations a lower expenditure on packaging is necessary than with less concentrated formulations. Similarly, the expenditure for production, transport and storage decreases; also, for example, the preparation of the spraying mixtures is simplified owing to the smaller quantities of for example pesticides which have to be handled, e.g. in the filling and mixing process.

The active substances from the 1,2,4-triazinones group, such as metamitron and metribuzin, are highly effective herbicides with activity against harmful plants in plant crops.

On the other hand metribuzin crystallizes easily, in particular at higher temperatures >40° C., leading to problems when preparing tank mixes from the formulation or worse, removing the active ingredient totally from the mix, for example by precipitation.

Isoxaflutole is a herbicide of the HPPD class effective e.g. against broadleaf or grass weeds in corn and soybean. Isoxaflutole degrades in formulations at a pH>5, or under certain conditions even at pH>4.

The task was now to provide suitable additive combinations as well as formulations with the active substances metribuzin and isoxaflutole with high physical (e.g. reduction of crystallization) and chemical (e.g. reduction of degradation) stability.

Surprisingly it has now been found that the combination of three specific surfactants provide chemical and physical stability to formulations, in particular suspension concentrates (SC), comprising metribuzin and isoxaflutole.

Hence, one aspect of the present invention is the use of the surfactant combination of the instant invention in highly effective herbicide formulations (composition) with activity against harmful plants in useful plant (crop plants), wherein preferably the composition has no harmful effect on the useful plant, wherein, more preferably, the useful plant is soybean.

Another aspect of the present invention is the use of the surfactant combination of the instant invention in agrochemical formulation, preferable wherein the agrochemical formulations comprise as active ingredients metribuzin and/or isoxaflutole.

Therefore, in one aspect of the present invention the surfactant combination for agrochemical formulations with metribuzin and isoxaflutole comprises:

1) at least one surfactant selected from the group consisting of salts of alkylnaphthalene sulphonic acids, salts of naphthalene-sulphonic acid-formaldehyde condensation products, salts of condensation products of naphthalenesulphonic acid, phenolsulphonic acid and formaldehyde, and salts of lignosulphonic acid. In particular, sodium salts of alkylnaphthalene sulphonic acids and salts of naphthalene-sulphonic acid-formaldehyde condensation products, e.g Morwet® D-425.

2) at least one surfactant selected from the group consisting of block-copolymers of polyethylene oxide and polypropylene oxide, in particular Synperonic® PE/F 127.

3) at least one surfactant selected from the group of methyl methacrylate graft copolymers with polyethylene glycol, e.g. Atlox® 4913.

In a preferred embodiment the surfactant combination is for use in metribuzin and isoxaflutole containing compositions for chemical and physical stabilization of said active ingredients.

In a preferred embodiment the surfactant combination comprises one salt of naphthalene-sulphonic acid-formaldehyde condensation products, i.e. Morwet® D-425, one block-copolymer of polyethylene oxide and polypropylene oxide, i.e. Synperonic® PE/F 127, and one methyl methacrylate graft copolymer with polyethylene glycol, i.e. Atlox® 4913.

Further preferred, the ratio of 1) to 2) to 3) is 1:3:5 for each of the components. In another embodiment the ratio of 1) to 2) to 3) is from 0.8:2.5:5 to 1.2:3.5:5.

If not otherwise indicated ratios always refer to weight ratio in the instant application, whereas % refers to % by weight (w/w).

In another aspect, the instant invention provides aqueous crop protectant compositions, said compositions comprising
(a) metribuzin,
(b) water,
(c1) at least one surfactant selected from the group of consisting of salts of alkylnaphthalene sulphonic acids, salts of naphthalene-sulphonic acid-formaldehyde condensation products, salts of condensation products of naphthalenesulphonic acid, phenolsulphonic acid and formaldehyde, and salts of lignosulphonic acid,
(c2) at least one surfactant selected from the group consisting of block-copolymers of polyethylene oxide and polypropylene oxide,
(c3) at least one surfactant selected from the group of methyl methacrylate graft copolymers with polyethylene glycol
(d) at least one organic acid,
(e) at least one rheological modifier,
(f) isoxaflutole,
(g) optionally, a base or buffer, and
(h) optionally, further customary formulation assistants,

wherein (c1)-(c3) correspond to the surfactant combination described above.

In a preferred embodiment (c1) is selected from the group of sodium salts of alkylnaphthalene sulphonic acids and salts of naphthalene-sulphonic acid-formaldehyde condensation products.

In a further preferred embodiment base (g) is mandatory.

The stated common names for active ingredients, such as metribuzin and isoxaflutole, are known to the skilled worker; see, for example, “The Pesticide Manual” British Crop Protection Council 2003; the names include the known derivatives such as salts, isomers, enantiomers and especially the commercially customary forms.

In another embodiment, the compositions of the instant invention comprise:

a) metribuzin,

b) water,

c) (c1)-(c3) as surfactant combination as described above,

d) a non-oxidizing organic acids, in particular citric acid, and

e) a rheological modifier

f) isoxaflutole.

g) an inorganic or organic base or buffer,

h) Suitable other formulants

In a preferred embodiment the organic acid is a non-oxidizing organic acid. In a more preferred embodiment the organic acid d) is selected from the group comprising oxalic acid, malonic acid, succinic acid, adipic acid, maleic acid, fumaric acid and citric acid as well as mixtures thereof. More preferred the organic acid is citric acid.

A rheological modifier e) is an additive that when added to the recipe at a concentration that reduces the gravitational separation of the dispersed active ingredient during storage, results in a substantial increase of the viscosity of the formulation at low shear rates. Low shear rates are defined as 0.1 s-1 and below and a substantial increase is greater than ×2 for the purpose of this invention. The viscosity can be measured by a rotational shear rheometer.

Suitable rheological modifiers e) by way of example are:
Polysaccharides including xanthan gum, guar gum and hydroxyethyl cellulose and Hydroxypropylmethyl cellulose (HPMC). Examples are Kelzan®, Rhodopol® G and 23, Satiaxane® CX911 and Natrosol® 250 range and Vivapur® K15M.
Clays including montmorillonite, bentonite, sepiolite, attapulgite, laponite, hectorite. Examples are Veegum® R, Van Gel® B, Bentone® CT, HC, EW, Pangel® M100, M200, M300, S, M, W, Attagel® 50, Laponite® RD,
Fumed and precipitated silica, examples are Aerosil® 200, Sipernat® 22S.

Preferred are xanthan gum, montmorillonite clays, bentonite clays and fumed silica.

Particularly preferred the rheological modifier is xanthan gum.

Suitable bases and buffers g) are all substances which can customarily be employed in agrochemical agents for this purpose wherein the base or buffer may be organic or inorganic. Preferably the base or buffer is selected from the group consisting of sodium hydroxide, disodium hydrogen phosphate (Na₂HPO₄), sodium dihydrogen phosphate (NaH₂PO₄), potassium dihydrogen phosphate (KH₂PO₄), potassium hydrogen phosphate (K₂HPO₄). In particular disodium hydrogen phosphate, often used as the dodecahydrate, is preferred as a base.

Formulants h) are preferably selected from biocides, antifreeze, colorants, pH adjusters, buffers, stabilizers, antifoam substances, antioxidants, inert filling materials, humectants, crystal growth inhibitors, micronutrients.

Suitable antifoam substances are all substances which can customarily be employed in agrochemical agents for this purpose. Silicone oils, silicone oil preparations are preferred. Examples are Silcolapse® 426 and 432 from Elkem, Silfoam® SRE and SC132 from Wacker, SAG® 1572 and SAG® 30 from Momentive [Dimethyl siloxanes and silicones, CAS No. 63148-62-9]. Preferred is Silcolapse® 454.

Possible preservatives are all substances which can customarily be employed in agrochemical agents for this purpose. Suitable examples for preservatives are preparations containing 5-chloro-2-methyl-4-isothiazolin-3-one [CAS-No. 26172-55-4], 2-methyl-4-isothiazolin-3-one [CAS-No. 2682-20-4] or 1,2-benzisothiazol-3(2H)-one [CAS-No. 2634-33-5]. Examples which may be mentioned are Preventol® D7 (Lanxess), Kathon® CG/ICP (Dow), Acticide® SPX (Thor GmbH) and Proxel® GXL (Arch Chemicals).

Suitable antifreeze substances are all substances which can customarily be employed in agrochemical agents for this purpose. Suitable examples are propylene glycol, ethylene glycol, urea and glycerin.

Possible colorants are all substances which can customarily be employed in agrochemical agents for this purpose. Titanium dioxide, carbon black, zinc oxide, blue pigments, Brilliant Blue FCF, red pigments and Permanent Red FGR may be mentioned by way of example.

Suitable stabilizers and antioxidants are all substances which can customarily be employed in agrochemical agents for this purpose. Butylhydroxytoluene [3,5-Di-tert-butyl-4-hydroxytoluol, CAS-No. 128-37-0] is preferred.

In accordance with the present invention, the herbicide combinations as defined herein or the composition comprising a herbicide combination as defined herein comprise a herbicidal effective amount of said herbicide combination and may comprise further components, for example agrochemical active compounds of a different type and/or formulation auxiliaries and/or additives customary in crop protection, or they may be employed together with these.

The type of active ingredients (a) and (f) used determine the type of pests which can be controlled by application of the crop protection compositions or agrochemical formulations. In case of herbicides the pests are undesired plants.

Further, the components (a) to (h) are present in the aqueous crop protectant compositions according to the present invention in the amounts as follows:
(a) 30%-45% metribuzin, preferably 33%-42%, most preferred 35-40%,
(b) water ad 100%, preferably 30%-50%, more preferred 35%-45%.
(c1) 0.6%-1.2%, preferably 0.7% to 1.0% and most preferred 0.8% of at least one surfactant selected from the group of consisting of salts of alkylnaphthalene sulphonic acids, salts of naphthalene-sulphonic acid-formaldehyde condensation products, salts of condensation products of naphthalenesulphonic acid, phenolsulphonic acid and formaldehyde, and salts of lignosulphonic acid,
(c2) 2.0%-3.0%, preferably 2.3% to 2.8%, and most preferred 2.5% of at least one surfactant selected from the group consisting of block-copolymers of polyethylene oxide and polypropylene oxide,
(c3) 3.5%-4.5%, preferably 3.8%-4.2% and most preferred 4.0% of at least one surfactant selected from the group of methyl methacrylate graft copolymers with polyethylene glycol,
(d) 0.01%-1.0%, preferably 0.03%-0.75% and most preferred 0.1%-0.4% of at least one organic acid,
(e) 0.01%-1.0%, preferably 0.05%-0.7% and most preferred 0.1%-0.5% of at least one rheological modifier,
(f) 5%-15%, preferably 6%-12% and most preferred 8%-10% isoxaflutole,
(g) 0%-5% of a base or buffer, preferably, 0.1%-1%, most preferred 0.3%-0.7%.
(h) 0%-10% of further customary formulation assistants, preferably 1%-9%, and most preferred 3%-7%,

wherein (c1)-(c3) correspond to the surfactant combination described above.

In the above formulation components a) to h) add up to 100%.

Further, it is understood, that the preferred given ranges of the respective ingredients as given above can be freely combined and all combinations are disclosed herein, however, in a more preferred embodiment, the ingredients are preferably present in the ranges of the same degree of preference, and even more preferred the ingredients a) to h) are present in the most preferred ranges.

The liquid formulations or suspensions of the invention can be prepared by methods which are customary in principle, i.e., by mixing the component s with stirring or shaking or by means of static mixing methods. The liquid formulations obtained are stable with good storage properties.

The liquid formulations comprising active ingredient and the adjuvant formulations are low-foam formulations with good storage properties. In many cases they have very favorable technical properties on application. By way of example the formulations are distinguished by a low tendency to aggregate, e.g. during storage, and high chemical stability of both active ingredients.

Accordingly the formulations of the invention are especially suitable for use in crop protection where the formulations are applied to the plants, to parts of plants or to the area under cultivation.

In the case of herbicidal ingredients (a) and/or (f) the formulations are very suitable for controlling unwanted plant growth both on uncultivated land and in tolerant crops.

Materials used:

ISOXAFLUTOLE CAS-No.: 141112-29-0, IUPAC name: 5-cyclopropyl-4-(2-methylsulfonyl-4-trifluoromethyl-benzoyl)-isoxazole (Bayer AG)

METRIBUZIN CAS-No.: 21087-64-9, IUPAC name: 4-amino-6-tert-butyl-4,5-dihydro-3-methylthio-1,2,4-triazin-5-one (Bayer AG) 1,2-PROPYLENE GLYCOL anti-freeze

ACTICIDE® B 20 Aqueous dipropylene glycol solution of approx. 20% 1,2-Benzisothiazolin-3-on as sodium salt (Thor GmbH)

ACTICIDE® SPX Microbicide based on Isothiazolones (Thor GmbH)

ATLOX® 4913 Ethoxylated polymethacrylate (graft copolymer) in water and propylene glycol

ATLOX® 4894 Ethoxylated C12-C15 fatty alcohol (15-30%)+EO-PO Block copolymer n-butyl (40-60%)+Water (10-20%) (CRODA)

CITRIC ACID ANHYDROUS poly organic acid, CAS number 5949-29-1

DINATRIUMPHOSPHAT-12-HYDRAT Disodium phosphate dodecahydrate, inorganic base CAS number 7558-79-4

MORWET® D-425 sodium naphthalene sulphonate formaldehyde condensate (Akzo Nobel)

RHODOPOL® 23 or G Xanthan Gum, Heteropolysaccharide (Solvay)

SILCOLAPSE® 454 Polydimethylsiloxanes and silica (Elkem Silicones)

SYNPERONIC® PE/F 127 Polyoxyethylene-polyoxypropylene block copolymer (CRODA).

The examples are shown in the following tables.

TABLE 1

| | Component | Amount in % |
|---|---|---|
| f | ISOXAFLUTOLE | 9.13 |
| a | METRIBUZIN | 36.52 |
| h | 1,2-PROPYLENE GLYCOL | 5 |
| h | ACTICIDE ® B 20 | 0.18 |
| h | ACTICIDE ® SPX | 0.08 |
| c | ATLOX ® 4913 | 4 |
| c | CITRIC ACID ANHYDROUS | 0.25 |
| g | DINATRIUMPHOSPHAT- | 0.55 |
| | 12-HYDRAT | |
| c | MORWET ® D-425 | 0.8 |
| e | RHODOPOL ® 23 or G | 0.15 |
| h | SILCOLAPSE ® 454 | 0.2 |
| c | SYNPERONIC ® PE/F 127 | 2.5 |
| b | DEMINERALISED WATER | 40.64 |

Components c) and h) are initially introduced into component b). Then, the finely-ground components g) and d) are added little by little with stirring, and last finely grounded component a), and f) are added with stirring. Milling on a WAB Research mill is started and continued until a homogeneous suspension has formed with a particle size d90 between 6-12 μm. After milling, component e) is added solo with stirring or in form of a gel.

The resulting suspension according to the invention is storage-stable over a prolonged period. Even upon prolonged storage, the solid constituents show only a very low tendency to crystallize (especially a)) and to form a hard sediment (caking) at high temperatures of 40° C. and 54° C. and the active substance a) and f) show only a very low degree of decomposition.

The suspension according to the invention can be diluted with water to give a homogeneous dispersion. It has outstanding activity against harmful plants while simultaneously being very well tolerated in crops of useful plants.

The storage stability of the formulation according to the invention, which is increased in comparison to a prior-art formulation, manifests itself for example in the form of a lesser degree of decomposition of the active substance of group a and f) upon storage at different temperatures. To this end, a first experiment involved preparing the abovementioned formulation according to the invention and, for comparison purposes, a similar formulation in accordance with the above-described method following the prior art and storing the products for 8 weeks at 40° C. and 2 weeks at 54° C. and seeing visually the degree of physical stability after storage.

In a second experiment, the degree of decomposition of the active substance of group A) was determined after storage for 8 weeks at a temperature of 40° C. and 2 weeks 54° C. The results in table 3 show that the formulation according to the invention shows a lower decomposition of the active substance of group a and f than the formulation prepared with the recipe disclosed in the prior art.

TABLE 2
Examples:

| | Amount in % | | | | |
|---|---|---|---|---|---|
| | | | Ex3 | | Ex5 |
| | Ex1 | Ex2 | This | Ex4 | This |
| | compar- | compar- | inven- | compar- | inven- |
| Component | ative | ative | tion | ative | tion |
| ISOXAFLUTOLE | 9.21 | 9.21 | 9.21 | 9.21 | 9.13 |
| METRIBUZIN | 36.84 | 36.84 | 36.84 | 36.84 | 36.52 |
| 1,2-PROPYLENE | 5 | 5 | 5 | 5 | 5 |
| GLYCOL | | | | | |
| ACTICIDE ® B 20 | 0.18 | 0.18 | 0.18 | 0.18 | 0.18 |
| ACTICIDE ® SPX | 0.08 | 0.08 | 0.08 | 0.08 | 0.08 |
| ATLOX ® 4913 | 4 | 6 | 4 | 4 | 4 |
| ATLOX ® 4894 | 2 | 2 | | | |
| CITRIC ACID | 0.05 | 0.05 | 0.05 | 0.05 | 0.25 |
| ANHYDROUS | | | | | |
| DINATRIUMPHOS- | | | | | 0.55 |
| PHAT-12-HYDRAT | | | | | |
| MORWET ® D-425 | | | 0.8 | 1.5 | 0.8 |
| RHODOPOL ® 23 | 0.15 | 0.15 | 0.15 | 0.15 | |
| RHODOPOL ® G | | | | | 0.15 |
| SILCOLAPSE ® 454 | 0.20 | 0.20 | 0.2 | 0.2 | 0.2 |
| SYNPERONIC ® ® | | | 2.5 | 2.5 | 2.5 |
| PE/F 127 | | | | | |
| DEMINERALISED | 42.29 | 40.29 | 40.99 | 40.29 | 40.64 |
| WATER | | | | | |

Comparative Examples Ex1 and Ex2 relate to prior art as cited in WO2011018188A2.

If not otherwise defined in the instant specification, particle size is measured according to CIPAC (CIPAC=Collaborative International Pesticides Analytical Council; www.cipac.org) method MT 187 determined as D50 respectively D90=active ingredient particle size (laser diffraction 50%, respectively 90% of overall volume particles The mean particle size denotes the D50 value.

Abbreviations used in the tables:

d90=in μm, 90 volume % of all particles lies below the stated diameter, CIPAC method CIPAC MT 187.

12WRT=storage 12 weeks at Room Temperature

2 weeks 54° C.=short storage at high temperature of 54° C. for two weeks

TABLE 3
Physical characterization:

| | | Ex1 | Ex2 | Ex3 | Ex4 | Ex5 |
|---|---|---|---|---|---|---|
| 12 WRT | Visual | Liquid | Liquid | Liquid | Liquid | Liquid |
| | appearance | suspension | suspension | suspension | suspension | suspension |
| | Particle | 36.08 | 17.58 | 2.61 | 2.48 | 5 |
| | size d90 | | | | | |
| | % hard, | 0 | 0 | 0 | 0 | 0 |
| | solid | | | | | |
| | sediment | | | | | |
| 2 weeks | Particle | not | not | 5.76 | not | 10.41 |
| 54° C. | size d90 | measurable | measurable | | measurable | |
| | | since solid | since solid | | since solid | |
| | | sample | sample | | sample | |
| | % hard, | 60 | 50 | 0 | 50 | 10 |
| | solid | | | | | |
| | sediment | | | | | |

From Table 3 one can see comparing the inventive examples with the comparative examples, that state of art recipes are not leading to a viable flowable recipe in the case where metribuzin is formulated together with isoxaflutole into a suspension concentrate. Due to metribuzin crystallization, a hard indissoluble sediment is formed upon storage, jeopardizing long term storage of the formulation. The comparative recipe cannot be industrialized and sold.

Validation of the recipe containing the base-parameter Ex6, following Ex5: isoxaflutole degradation, hard sediment and d90 as comparative parameters, wherein the base g) is present and the amount of citric acid adapted accordingly.

TABLE 4
Ex. 6-11

| | |
|---|---|
| ISOXAFLUTOLE | 9.13 |
| METRIBUZIN | 36.52 |
| 1,2-PROPYLENE GLYCOL | 5 |
| ACTICIDE ® B 20 | 0.18 |
| ACTICIDE ® SPX | 0.08 |
| ATLOX ® 4913 | 4 |
| CITRIC ACID ANHYDROUS | 0.25 |
| DINATRIUMPHOSPHAT- | 0.55 |
| 12-HYDRAT | |
| MORWET ® D-425 | 0.8 |
| RHODOPOL ® G or 23 | 0.15 |
| SILCOLAPSE ® 454 | 0.2 |
| SYNPERONIC ® PE/F 127 | 2.5 |
| DEMINERALISED WATER | 40.64 |

TABLE 5
Physical storage parameters for samples
stored at 2 weeks at 54° C.:

| | | | Hard | Isoxaflutole |
|---|---|---|---|---|
| | Visual | | sediment | degradation |
| example | appearance | d90 | in % | in % |
| 6 | Liquid | 15.82 | 4 | 6.14 |
| | suspension | | | |
| 7 | Liquid | 15.01 | 4 | 7.7 |
| | suspension | | | |
| 8 | Liquid | 20.66 | 6 | 6.16 |
| | suspension | | | |
| 9 | Liquid | 21.10 | 3 | 6.66 |
| | suspension | | | |
| 10 | Liquid | 21.72 | 3 | 6.35 |
| | suspension | | | |
| 11 | Liquid | 18.90 | 6 | 6.01 |
| | suspension | | | |

Table 5 shows Examples 6 to 11 prepared with the same recipe according to table 4 and reveals validation and reproducibility of quality and physical parameters for inventive recipe of Ex5 with base added. Isoxaflutole degradation must be as lowest as possible, max 10% to have a viable product. Very little hard sediment is formed, mostly re-homogenizable by shaking.

Particle size stays within limits and will not cause filter blockage when formulation is sprayed.

Validation of the recipe containing NO base-parameter, following Example 3: isoxaflutole degradation, hard sediment and d90 as comparative parameters. Here no base is used thus one needs much less citric acid. The same parameters as for Ex5 are compared.

TABLE 6
Recipe Ex. 12 and 13:

| | |
|---|---|
| ISOXAFLUTOLE | 9.13 |
| METRIBUZIN | 36.52 |
| 1,2-PROPYLENE GLYCOL | 5 |
| ACTICIDE ® B 20 | 0.18 |
| ACTICIDE ® SPX | 0.08 |
| ATLOX ® 4913 | 4 |
| CITRIC ACID ANHYDROUS | 0.05 |
| MORWET ® D-425 | 0.8 |
| RHODOPOL ® 23 | 0.15 |
| SILCOLAPSE ® 454 | 0.2 |
| SYNPERONIC ® PE/F 127 | 2.5 |
| DEMINERALISED WATER | 41.39 |

TABLE 7
Physical storage parameters for samples
stored at 2 weeks at 54° C.:

| | | | Hard | Isoxaflutole |
|---|---|---|---|---|
| | Visual | | sediment | degradation |
| example | appearance | d90 | in % | in % |
| 12 | Liquid | 5.67 | 0 | 1.64 |
| | suspension | | | |
| 13 | Liquid | 5.63 | 0 | 1.89 |
| | suspension | | | |

Table 7 with Examples 12 and 13 with recipes according to table 6 reveals validation and reproducibility of quality and physical parameters for inventive recipe of Ex3 with no base added. Isoxaflutole degradation must be as lowest as possible, max 10% to have a viable product; here we reach minimal values showing that without base the recipe is even more stable. No hard sediment is formed. Particle size stay within limits and will not cause filter blockage when formulation is sprayed.

1. A surfactant combination for an agrochemical formulation comprising:
1) at least one surfactant selected from the group of consisting of salts of alkylnaphthalene sulphonic acids, salts of naphthalene-sulphonic acid-formaldehyde condensation products, salts of condensation products of naphthalenesulphonic acid, phenolsulphonic acid and formaldehyde, and salts of lignosulphonic acid,
2) at least one surfactant selected from the group consisting of block-copolymers of polyethylene oxide and polypropylene oxide,
3) at least one surfactant selected from the group of methyl methacrylate graft copolymers with polyethylene glycol, and
at least one organic acid.

2. Surfactant combination for agrochemical formulation according to claim 1, wherein the ratio of 1) to 2) to 3) is 1:3:2.5:5.

3. Surfactant combination for agrochemical formulation according to claim 1, wherein the ratio of 1) to 2) to 3) is from 0.8:2.5:5 to 1.2:3.5:5 to 1:3.125:5.

4. An aqueous crop protectant composition comprising:
(a) metribuzin,
(b) water,
(c1) at least one surfactant selected from the group of consisting of salts of alkylnaphthalene sulphonic acids, salts of naphthalene-sulphonic acid-formaldehyde condensation products, salts of condensation products of naphthalenesulphonic acid, phenolsulphonic acid and formaldehyde, and salts of lignosulphonic acid,
(c2) at least one surfactant selected from the group consisting of block-copolymers of polyethylene oxide and polypropylene oxide,
(c3) at least one surfactant selected from the group of methyl methacrylate graft copolymers with polyethylene glycol;
(d) at least one organic acid,
(e) at least one rheological modifier,
(f) isoxaflutole,
(g) optionally a base or buffer,
(h) optionally, one or more further customary formulation assistants, and
wherein (c1)-(c3) correspond to the surfactant combination of claim 1.

5. The crop protectant composition according to claim 4, wherein c1) is selected from the group of sodium salts of alkylnaphthalene sulphonic acids and salts of naphthalene-sulphonic acid-formaldehyde condensation products.

6. The crop protectant composition according to claim 4, wherein component (d) is citric acid.

7. The crop protectant composition as claimed in claim 4, wherein component (g) is present.

8. The crop protectant composition according to claim 4, comprising
(a) 30%-45% metribuzin, optionally 33% 42%, optionally 35-40%,
(b) water ad 100%, optionally 30% 50%, optionally 35%-45%,
(c1) 0.6%-1.2%, optionally 0.7% to 1.0% and optionally 0.8% of at least one surfactant selected from the group of consisting of salts of alkylnaphthalene sulphonic acids, salts of naphthalene-sulphonic acid-formaldehyde condensation products, salts of condensation products of naphthalenesulphonic acid, phenolsulphonic acid and formaldehyde, and salts of lignosulphonic acid,
(c2) 2.0%-3.0%, optionally 2.3% to 2.8%, and optionally 2.5% of at least one surfactant selected from the group consisting of block-copolymers of polyethylene oxide and polypropylene oxide,
(c3) 3.5%-4.5%, optionally 3.8%-4.2% and optionally 4.0% of at least one surfactant selected from the group of methyl methacrylate graft copolymers with polyethylene glycol,
(d) 0.01%-1.0%, optionally 0.03%-0.75% and optionally 0.1%-0.4% of at least one organic acid,
(e) 0.01%-1.0%, optionally 0.05%-0.7% and optionally 0.1%-0.5% of at least one rheological modifier,
(f) 5%-15%, optionally 6%-12% and optionally 8%-10% isoxaflutole,
(g) 0%-5% of a base or buffer, optionally, 0.1%-1%, optionally 0.3%-0.7%,
(h) 0%-10% of one or more further customary formulation assistants, optionally 1%-9%, and optionally 3%-7%.

9. The crop protectant composition according to claim 4, wherein the component g is present.

10. The crop protectant composition according to claim 8, wherein the components (a) to (h) add up to 100%.

11. A product comprising the surfactant composition of claim 1 for a crop protection formulation.

12. A product comprising the crop protectant compositions according to claim 4, in a highly effective herbicide formulation (composition) with activity against one or more harmful plants in a useful plant, wherein optionally the composition has no harmful effect on the useful plant, wherein, optionally, the useful plant is soybean.
